(19) United States
(12) Patent Application Publication
(10) Pub. No.: US 2022/0017040 A1
(43) Pub. Date: Jan. 20, 2022

(54) Trailer Landing Gear Leg Lock

(71) Applicant: Joseph Volpe, Fort Oglethorpe, GA (US)

(72) Inventor: Joseph Volpe, Fort Oglethorpe, GA (US)

(21) Appl. No.: 17/367,734

(22) Filed: Jul. 6, 2021

Related U.S. Application Data
(60) Provisional application No. 63/051,954, filed on Jul. 15, 2020.

(51) Int. Cl. B60R 25/00; B60S 9/04; E05B 67/38

(52) U.S. Cl. CPC B60R 25/001; E05B 2047/0095; E05B 67/38; B60S 9/04

(57) ABSTRACT

The present invention relates to a trailer landing gear leg lock device that prevents the unauthorized retraction of a trailer landing gear leg to prevent a trailer from being stolen. The lock device is further comprised of two hinge-connected halves that can be placed around the landing gear leg of a trailer, wherein the halves can then be locked together via a locking mechanism. In differing embodiments of the lock device, the locking mechanism may be secured by a plurality of housings and compartments, as well a plurality of additional locks and lock covers. The device may further comprise a plurality of other theft resistant devices and accessories.

### CROSS-REFERENCE TO RELATED APPLICATION

The present application claims priority to, and the benefit of, U.S. Provisional Application No. 63/051,954, which was filed on Jul. 15, 2020 and is incorporated herein by reference in its entirety.

### FIELD OF THE INVENTION

The present invention relates generally to the field of trailer locking devices. More specifically, the present invention relates to a trailer landing gear leg lock device that inhibits the retraction of the trailer landing gear leg, thereby preventing the trailer from being stolen. The leg lock device is comprised of two hinge-connected halves that can be placed around the landing gear leg of a trailer, wherein the halves can then be locked together via a locking mechanism. In differing embodiments of the leg lock device, the locking mechanism may be secured by a plurality of housings and/or compartments, as well as a plurality of additional locks and lock covers. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Semi-trailers and other commercial, industrial and recreational trailers are regularly used to transport both goods and people. Said trailers can also be detached from a semi-truck or towing vehicle and stored on their own while being supported by a retractable landing gear that can be found on almost every trailer. More specifically, the trailer landing gear supports the front portion of the trailer and is typically comprised of at least one gear-driven telescopic leg that is mounted near the front end of the trailer. This leg can further be used to lift and/or lower the trailer to allow it to be attached/detached from a semi-truck or other towing vehicle.

Traditionally, the hitch portion of the trailer landing gear that attaches to a semi-trailer or other towing vehicle can be locked with external locking devices to prevent the attachment of the trailer to an unauthorized towing vehicle. Such locking devices typically prevent the socket portion of the trailer hitch from being attached to the ball portion of a vehicle or semi-trailer hitch, wherein the trailer can then only be attached to a towing vehicle or semi-truck when the lock is removed. However, the landing gear of the trailer can still be raised or lowered, as no existing trailer lock prevents the unauthorized raising or lowering of the landing gear. Accordingly, the trailer is still susceptible to theft because the landing gear is capable of being retracted which will allow the trailer to be moved. Further, a thief may also simply defeat the existing hitch lock (which is typically in the form of an exposed padlock) to gain access to the trailer, and attach it to a towing vehicle. However, if the retraction of the landing gear is inhibited, a trailer cannot be stolen or moved, even if a thief has devised a means to circumvent or defeat an existing hitch lock device that may be attached to the trailer.

Therefore, there exists a long felt need in the art for an improved trailer lock that better protects a trailer against theft. More specifically, there is a long felt need in the art for a trailer landing gear leg lock device that prohibits the unauthorized retraction of the trailer landing gear leg lock. Further, there is a long felt need in the art for a trailer landing gear leg lock device that is relatively easy to engage and disengage, thereby saving both time and money. Additionally, there is a long felt need in the art for a trailer landing gear leg lock device that notifies a remote owner or operator if the trailer landing gear leg has been repositioned without authorization, so that the appropriate authorities may be notified. Finally, there is a long felt need in the art for a trailer landing gear leg lock device that is relatively inexpensive to manufacture and both safe and easy to use.

The subject matter disclosed and claimed herein, in one embodiment thereof, comprises a trailer landing gear leg lock device that secures a trailer against theft by inhibiting the retraction of the landing gear leg. The lock device is further comprised of two hinge-connected halves that can be placed around and enclose the landing gear of a trailer, wherein the halves can then be locked together via a locking mechanism to secure the landing gear as well as any chains that could be used to attach the trailer to a towing vehicle. In differing embodiments of the device, the locking mechanism may be secured by a plurality of housings and compartments that are integrally formed into each half of the device. Further, the device may also be comprised of a plurality of additional locks and lock covers that further decrease the probability of any locking mechanisms on the device becoming defeated. Finally, the device may also comprise a wireless communication module with GPS capabilities that may be paired to a mobile application on a remote electronic device to notify an owner/operator if the trailer leg has been repositioned without authorization and the precise location of the device and, therefore, the trailer.

In this manner, the trailer landing gear leg lock device of the present invention accomplishes all of the forgoing objectives and provides an improved trailer lock that better protects a trailer against theft than existing trailer lock devices known in the art. More specifically, the trailer landing gear leg lock device prevents trailer theft by inhibiting the retraction of the landing gear leg. Finally, the trailer landing gear leg lock device also notifies an owner/operator of the unauthorized retraction of the trailer landing gear, and the precise location of the trailer at all times.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a novel trailer landing gear leg lock device. More specifically, the leg lock device is comprised of two metal halves that are connected to one another via at least one hinge, wherein the halves can be placed around and enclose the landing gear of a trailer to prevent the same from being repositioned without authorization. Each of the two halves is further comprised of a front, a rear and a sidewall, wherein when the two halves are combined together to enclose the landing gear. The two halves form a generally rectangular and elongated shape.

Each of the two halves is also comprised of a base plate and a latch having a continuous opening therein. As such, when the leg lock device is in a closed position around a landing gear leg, a lock, such as a padlock or combination lock, can be placed through the continuous opening of the latch of each half to effectively lock both halves of the device to one another. When the two halves are locked together, the novel leg lock device cannot be removed from the trailer landing gear leg nor can the landing gear leg be repositioned or retracted, thereby preventing the trailer from being stolen or moved without authorization.

In a further embodiment of the present invention, the locking mechanism of the leg lock device may comprise varying types of locks such as, without limitation, padlocks, combination locks or a hidden shackle lock, wherein the lock is protected from tampering on each half of the lock via a plurality of compartments/coverings. In addition, in a preferred embodiment, the device may be comprised of a housing that encloses a portion of the padlock, wherein the bottom surface of the housing is comprised of a hinge and a separate locking mechanism that requires a user first unlock the bottom surface, and then subsequently access the attached lock to unlock the device and remove it from around the landing gear leg. Further, any towing chains that may be present on a trailer can be tucked within the lock device to ensure that the chains cannot be attached to the towing vehicle of an unauthorized individual.

Additionally, as stated above, in yet a further embodiment of the present invention, the device may comprise a wireless communication module with GPS capabilities that may be paired to a mobile application on a remote electronic device to notify an owner/operator if the trailer leg has been repositioned without authorization and the precise location of the device and, therefore, the trailer.

Accordingly, the trailer landing gear leg lock device of the present invention is particularly advantageous as it offers increased trailer security and theft prevention over existing trailer hitch locks. Further, the trailer landing gear leg lock device can be easily used in conjunction with various trailer hitch locks to secure a trailer, and contains a plurality of additional security features that discourage and prevent thieves from disabling, breaking or picking the lock. Finally, the novel trailer landing gear leg lock device enables an owner/operator to remotely monitor the status of the device, and therefore the trailer, via the wireless communication module.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a trailer landing gear leg lock device of the present invention in an opened position in accordance with the disclosed architecture;

FIG. 2 illustrates a front perspective view of one potential embodiment of a trailer landing gear leg lock device of the present invention in a closed position while locked around a trailer landing gear leg in accordance with the disclosed architecture;

FIG. 3 illustrates a rear perspective view of one potential embodiment of a trailer landing gear leg lock device of the present invention in a closed position while locked around a trailer landing gear leg in accordance with the disclosed architecture; and

FIG. 4 illustrates a front perspective view of another potential embodiment of a trailer landing gear leg lock device of the present invention in a closed position while locked around a trailer landing gear leg in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved trailer lock that better protects a tractor trailer against theft or unauthorized use. More specifically, there is a long felt need in the art for a trailer landing gear leg lock device that prohibits the unauthorized retraction of the trailer landing gear leg lock, which could result in the theft of the trailer. Further, there is a long felt need in the art for a trailer landing gear leg lock device that is relatively easy to engage and disengage, thereby saving both time and money. Additionally, there is a long felt need in the art for a trailer landing gear leg lock device that notifies a remote owner or operator if the trailer landing gear leg has been repositioned without authorization so that the appropriate authorities may be notified. Finally, there is a long felt need in the art for a trailer landing gear leg lock device that is relatively inexpensive to manufacture and both safe and easy to use.

The present invention, in one exemplary embodiment, is comprised of a trailer landing gear leg lock device having two metal halves that are hinge-connected to one another, and as such can be placed around and enclose the landing gear leg of a trailer to prevent the same from being repositioned with authorization. Each half portion is further comprised of an integrally formed front, rear and sidewall that form a generally u-shaped half, such that when enclosed around a landing gear leg with the corresponding half, form a generally rectangular and elongated shape. As such, no portion of the landing gear leg is capable of being accessed.

In addition, each half portion has a base plate that is comprised of a latch having a continuous opening. As such, when the lock device is in a closed position around the landing gear leg, a lock, such as a padlock, can be placed through each continuous opening in each latch of each half portion to effectively lock both halves of the lock device to one another. As such, the lock device cannot be removed from the landing gear leg and therefore protects the leg from being retracted, which would otherwise allow the trailer to be stolen.

Further, in differing embodiments of the landing gear leg lock device, the locking mechanism may contain a plurality of differing lock types, such as the various lock types referenced above. For example, the locking mechanism can be comprised of a hidden shackle lock, wherein the lock is protected from tampering on each half of the lock via a plurality of compartments/coverings. In addition, the landing gear leg lock device may also be comprised of a housing that encloses a portion of the padlock, wherein the bottom surface of the housing is comprised of a hinge and a separate locking mechanism that requires a user to first unlock the bottom surface, and then subsequently access the attached lock to unlock the device and remove it from around the landing gear. Further, any towing chains that may be present on the trailer can also be tucked within the lock to ensure that the chains cannot be attached to the towing vehicle of an unauthorized individual.

Moreover, in yet a further embodiment of the present invention, the landing gear leg lock device may comprise a wireless communication module with GPS capabilities that may be paired to a mobile application on a remote electronic device to notify an owner/operator if the trailer leg has been repositioned without authorization and the precise location of the device and, therefore, the trailer. The wireless communication module and the sensor that determines whether the trailer leg has been repositioned may further comprise a battery for powering the same.

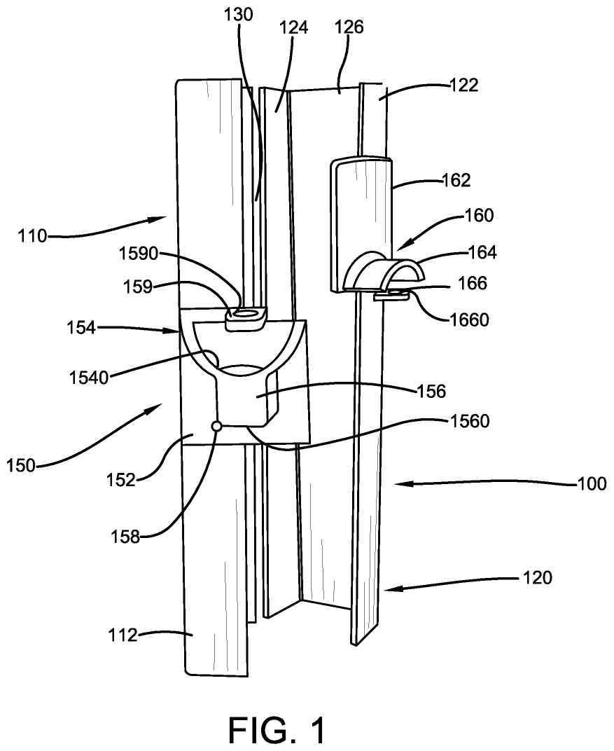

Referring initially to the drawings, FIG. 1 illustrates a perspective view of one potential embodiment of a trailer landing gear leg lock device 100 of the present invention in an opened position in accordance with the disclosed architecture. The lock device 100 is designed to prevent theft of a trailer by securely enclosing the landing gear leg of the trailer and preventing the same from being retracted, which could result in the trailer being moved without authorization or stolen. In differing embodiments, the trailer landing gear leg lock device 100 of the present invention may be adapted for use with manual or automatic trailer landing gear that may be found on commercial, industrial, or recreational trailers such as, but not limited to: semi-trailers, utility trailers, fifth-wheel trailers, camper trailers, etc. Further embodiments of the trailer landing gear leg lock device 100 may also be optimized to prevent the raising, lowering, attachment or detachment of other trailer-related features such as, but not limited to: a trailer hitch attachment, a goose-neck trailer attachment, a fifth-wheel trailer attachment, etc.

In the preferred embodiment of the trailer landing gear leg lock device 100, the device 100 is comprised of a first half portion 110 and a second half portion 120. The first half 110 is further comprised of a front wall 112, a sidewall 114 and a rear wall 116 that form the first half 110 in a generally u-shaped structure. Similarly, the second half 120 is comprised of a front wall 122, a sidewall 124 and a rear wall 126 that form the second half 120 in a generally u-shaped structure. It is contemplated that each of the halves 110, 120 of the trailer landing gear leg lock device 100 may be integrally formed as a single unit, or that the various walls may be singularly formed and welded together. It is further contemplated that each of the halves 110, 120 of the trailer landing gear leg lock device 100 may be comprised of a durable material that is not easily compromised and that is generally weather resistant such as, but not limited to: cast-iron, stainless steel, aluminum, etc.

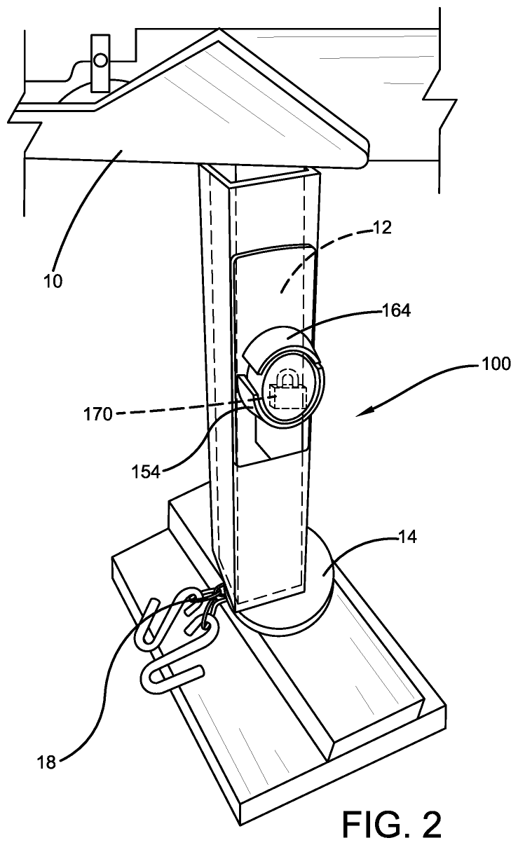

Each of the halves 110, 120 is further connected to the other via at least one hinge 130, such that when the halves 110, 120 are closed form a generally rectangular and elongated shape as best shown in FIGS. 2, 3 and 4. Nonetheless, the trailer landing gear leg lock device 100 is not so limited and in differing embodiments of the lock device 100, the shape of the lock device 100 when closed may be any of a plurality of different non-geometric or geometric shapes such as, but not limited to: cylindrical, triangular, octagonal, etc. Further, in differing embodiments, the hinge 130 may be any of a plurality of different hinge types such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, etc. Accordingly, the at least one hinge 130 allows both halve portions 110, 120 of the lock device 100 to be placed around the landing gear 12 of a trailer 10 to enclose the same as more fully explained below.

The lock device 100 is further comprised of a locking mechanism having a lower half 150 and an upper half 160. The lower half 150 of the mechanism is preferably fixedly connected (e.g., welded, integrally formed, etc.) to the front wall 112 of the first half 110 via a base plate 152. The base plate 152 is comprised of a generally convex housing 154 having an opening 1540. The bottom of the housing 154 is further comprised of a rectangular structure 156 that can house and receive the base of a lock 170 (e.g., a padlock) in differing embodiments of the lock 100. The bottom surface 1560 of the rectangular structure 156 may further be comprised of a hinge 158 that allows the bottom surface 1560 to be repositioned thereby providing access to the bottom portion of a padlock 170 that is housed within the convex housing 154. The bottom surface 1560 may also be unlocked via a plurality of security means such as, but not limited to: a bio-metric lock, a key lock, a keypad lock, an RFID lock, a smart lock that is unlocked via a Bluetooth connection and a mobile application, etc. As such, the locking of the bottom surface 1560 prevents a thief or other unauthorized individual from gaining access to and disabling the lock 170 contained within the housing 154. Further, the base plate 152 is comprised of a latch 159 with a continuous opening 1590 therein that allows a padlock/lock 170 to be placed through the opening 1590 as more fully explained below.

Similarly, the upper half 160 of the mechanism is preferably fixedly connected (e.g., welded, integrally formed, etc.) to the front wall 122 of the second half 120 via a base plate 162. The base plate 162 is comprised of a generally convex, semi-circular housing 164 that prevents a thief from cutting and removing the shackle of a padlock 170 within the lock device 100 by blocking access to the top of the shackle. The base plate 162 is also comprised of a latch 166 having a continuous opening 1660 therein. As such, after a user closes both halves 110, 120 of the trailer leg lock device 100 around the trailer's landing gear 12, the shackle of the padlock 170 can be placed through the opening 1660 of the latch 166 located on the second half 120 of the lock 100, and then placed through the opening 1590 of the latch 159 located on the first half 110 of the lock 100. In this manner, the padlock 170 secures the lock device 100 in a closed position around the landing gear leg 12 of a trailer 10, wherein a user can then lock the bottom surface 1560 after locking the padlock 170 to ensure that a thief cannot access the padlock 170 or its keyhole.

FIG. 2 illustrates a front perspective view of one potential embodiment of a trailer landing gear leg lock device 100 of the present invention in a closed position while locked around a trailer 10 landing gear leg 12 in accordance with the disclosed architecture. In differing embodiments of the lock device 100, the padlock 170 that is secured within the device 100 may be covered by a circular, locking cover 172. The cover 172 may be comprised of its own locking mechanism 174 such as, but not limited to: a bio-metric lock, a rotating dial lock, a key lock, a key pad lock, an RFID lock, a smart lock that is unlocked via a Bluetooth connection and a mobile application, etc. that prevents a thief from further accessing the shackle of the padlock 170 underneath the cover 172 or the entirety of the padlock 170 (depending on whether the entirety of the padlock 170 can fit within the cover or partially fits within the rectangular structure 156).

In a further embodiment of the lock 100, the locking mechanism 172 may include a hidden shackle lock in place of a padlock 170, or other locking means that may be fixedly attached (e.g., welded) to one or both halve portions 110, 120 of the landing gear leg lock device 100. In addition, the chain 18 that is typically attached to a trailer's 10 landing gear 12 may be placed inside and enclosed by the lock device 100 to further prevent thieves from attaching the chain 18 to a towing vehicle to ultimately steal the trailer 10.

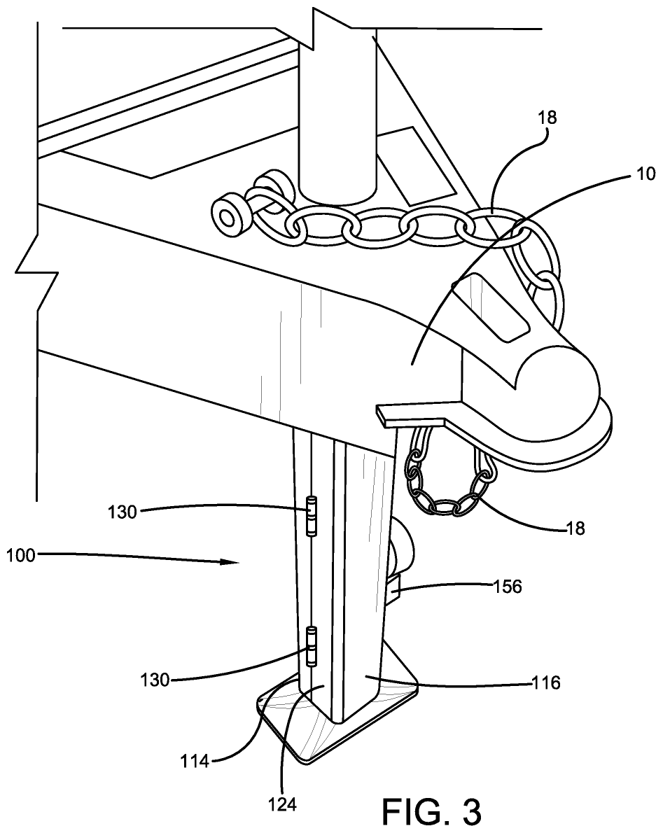

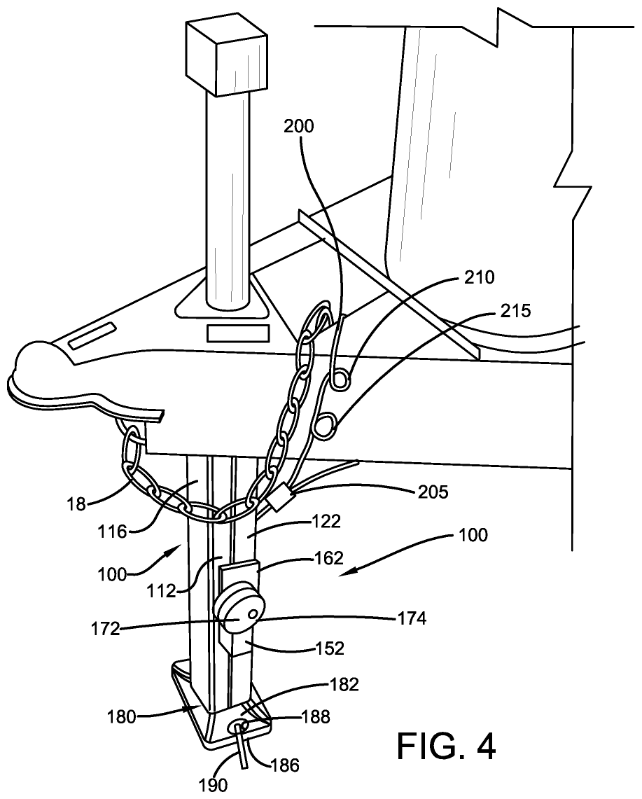

As best seen in FIGS. 3 and 4, the trailer landing gear leg lock device 100 may also be comprised of a base plate cover 180 that encloses the base plate 14 of the landing gear and further inhibits its movement. Although, differing embodiments of the lock device 100 may not enclose the base plate 14 of the landing gear 12, as best seen in FIG. 2. Further, the base plate cover 180 may be comprised of a top surface 182, a bottom surface 184, and a plurality of side surfaces 186, as well as a plurality of continuous openings 188 that allow a ground spike 190 or similar anchoring device to be driven through the opening 188 to further secure the base plate cover 180 to the ground and prevent movement of the landing gear 12.

As best seen in FIG. 4, the trailer landing gear leg lock device 100 may also comprise a tether 200 that is comprised of cut-resistant material. One end of the tether 200 is preferably fixedly attached to a surface of the first half 110 or the second half 120, and can be looped around a portion of the trailer 10 frame such that it can be reattached to itself via a clasp 205. The tether 200 is preferably also comprised of a speaker 210 and at least one LED 215. In the event that the tether 200 is successfully cut during an attempted theft, the speaker 210 will emit a high frequency alarm sound and at least one LED 215 will rapidly flash until both are disabled by a user via a mobile application 235 that is in wireless communication with both the speaker 210 and the at least one LED 215.

Additionally, as stated above and best shown in FIG. 4, in yet a further embodiment of the present invention, the trailer landing gear leg lock device 100 may further comprise a wireless communication module 220 with GPS capabilities that may be paired to a mobile application 235 on a remote electronic device 230 to notify an owner/operator (not shown) if the trailer landing gear leg 12 has been repositioned without authorization, and the precise location of the device 100 and, therefore, the trailer 10. More specifically, a sensor 222 may be positioned on the trailer landing gear leg 12 to detect its movement and send a signal to the wireless communication module 220 which, can in turn, send an alert to the mobile application 235 on the owner/operator's remote electronic device 230. Further, in the event that the trailer 10 has been stolen, the owner/operator of the authorities can easily locate the trailer via the GPS capabilities of the wireless communication module 220. Each of the speaker 210, the LED light 215, the sensor 222 and the wireless communication module 230 may be powered by an onboard rechargeable battery 225.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “lock device”, “device”, and “trailer landing gear leg lock device” are interchangeable and refer to the trailer landing gear leg lock device 100 of the present invention.

Notwithstanding the forgoing, the trailer landing gear leg lock device 100 of the present invention and its various components can be of any suitable size and configuration as is known in the art without affecting the overall concept of the invention, provided that they accomplish the above-stated objectives. One of ordinary skill in the art will appreciate that the size, configuration and material of the trailer landing gear leg lock device 100 as shown in the FIGS. are for illustrative purposes only, and that many other sizes and shapes of the trailer landing gear leg lock device 100 are well within the scope of the present disclosure. Although the dimensions of the trailer landing gear leg lock device 100 are important design parameters for user convenience, the trailer landing gear leg lock device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trailer landing gear leg lock device for locking a landing gear of a trailer, the trailer landing gear leg lock comprising:
a body portion comprised of a first half and a second half;
a lock; and
a latch.

2. The trailer landing gear leg lock device of claim 1, wherein the first half and the second half are connected to one another via at least one hinge, and further wherein the body portion is repositionable between an open position and a closed position.

3. The trailer landing gear leg lock device of claim 2, wherein lock is a padlock.

4. The trailer landing gear leg lock device of claim 3, wherein the lock engages the latch and secures the body portion around a leg of the landing gear.

5. A trailer landing gear leg lock device for locking a landing gear of a trailer, the landing gear leg lock comprising:
a generally rectangular body portion comprised of a first half and a second half;
a first latch having a first continuous opening therein connected to the first half;
a second latch having a second continuous opening therein connected to the second half; and
a locking mechanism for securing the first and second halves to one another.

6. The trailer landing gear leg lock device of claim 5 further comprising a sensor in communication with a wireless communication module.

7. The trailer landing gear leg lock device of claim 6 further comprising a tether, a speaker and at least one LED light.

8. The trailer landing gear leg lock device of claim 7 further comprising a battery.

9. The trailer landing gear leg lock device of claim 8, wherein the speaker emits an alarm when the tether is cut.

10. The trailer landing gear leg lock device of claim 8, wherein the at least one LED light is activated when the tether is cut.

11. The trailer landing gear leg lock device of claim 8, wherein the sensor senses when the landing gear of the trailer has been tampered with and sends a signal to the wireless communication module.

12. A trailer landing gear leg lock device for locking a landing gear of a trailer, the landing gear leg lock comprising:
a generally rectangular body that is comprised of a first half and a second half repositionably connected to one another via at least one hinge, wherein the generally rectangular body encloses a landing gear leg when in a closed position;
a first latch having a first continuous opening therein connected to the first half;
a second latch having a second continuous opening therein connected to the second half;
a locking mechanism capable of being extended through each of the first and second continuous openings; and
a tether having a speaker and at least one LED.

13. The trailer landing gear leg lock device of claim 12, wherein the generally rectangular body is comprised of a compartment that houses a lock.

14. The trailer landing gear leg lock device of claim 13, wherein the lock is a select one of a bio-metric lock, a key lock, a keypad lock, an RFID lock, or a smart lock that is unlocked via a Bluetooth connection and a mobile application.

15. The trailer landing gear leg lock device of claim 13, wherein the compartment comprises a hinge.

16. The trailer landing gear leg lock device of claim 15 further comprising a base plate having a plurality of continuous openings therein for receipt of a ground spike.

17. The trailer landing gear leg lock device of claim 12, wherein the locking mechanism is a hidden shackle lock.

18. The trailer landing gear leg lock device of claim 12, wherein the locking mechanism is a padlock.

19. The trailer landing gear leg lock device of claim 12, wherein the speaker emits an alarm when the tether is cut.

20. The trailer landing gear leg lock device of claim 12, wherein the at least one LED light is activated when the tether is cut.
